(19) United States
(12) Patent Application Publication
(10) Pub. No.: US 2009/0002331 A1
(43) Pub. Date: Jan. 1, 2009

(54) LIQUID CRYSTAL DISPLAY DEVICE

(75) Inventors: Kiyoshi Kamiya, Sayama (JP); Takashi Akiyama, Sayama (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: CITIZEN HOLDINGS CO., LTD., Tokyo (JP)

(21) Appl. No.: 12/130,469

(22) Filed: May 30, 2008

(30) Foreign Application Priority Data
Jun. 1, 2007 (JP) 2007-146861

(51) Int. Cl. G06F 3/041; G09G 3/36

(52) U.S. Cl. 345/173; 345/102

(57) ABSTRACT

A liquid crystal display panel having a liquid crystal between two flexible substrates, a light guide sheet of a lighting device capable of emitting lights of a plurality of colors to illuminate the liquid crystal display panel, and a switch sheet which senses a press thereon are stacked in this order so that the switch sheet can be locally pressed from the front surface side of the liquid crystal display panel. A circuit is further provided which causes the lighting device to repeat an illumination period in which only a light of a predetermined color of the lights of the plurality of colors is used, for each of the colors in order, and drives the liquid crystal display panel on an FSC basis in synchronization with the illumination period for each of the colors.

### BACKGROUND OF THE INVENTION

1. Field of the Invention

The present invention relates to a liquid crystal display device having a flexible liquid crystal display panel and a switch sheet which senses a press thereon stacked one on top of the other.

2. Description of the Related Art

Currently, an apparatus is widely known which provides various functions and services according to a touch input that is a contact or a press on switch (operation button) regions displayed on a display body. For example, there is an apparatus in which a touch panel of a resistance detection type which identifies a contact position from a resistance value of transparent electrodes is stacked on a color liquid crystal display panel, to display various touch input switches with explanation of the operation method and the operation status.

On the other hand, a press at a certain level needs to be applied on the touch panel of the resistance detection type, and therefore an optical type touch panel may be used when the display body is not suitable for this press.

For example, Patent Document 1 discloses an apparatus in which an optical type touch panel is provided on a liquid crystal display panel which performs color display by field sequential color drive. This optical type touch panel is composed of a light guide plate, a light source making light incident on a side surface of the light guide plate almost perpendicular to it, and an array of light receiving elements arranged on a side surface opposed to the former side surface.

In this touch panel, when a pen having a refractive index at its tip larger than the refractive index of the light guide plate is brought into contact with the surface of the light guide plate, light traveling in the light guide plate toward the light receiving element while repeatedly totally-reflected is absorbed into the pen tip at the contact point. This reduces the amount of light reaching a specific light receiving element, from such information the positional information of the pen tip is obtained. Patent Document 1 describes that combination with the FSC-drive type liquid crystal display panel allows for precise display of the position for the pen tip to contact.

Incidentally, the usage of the colors of the displayed switches which are changed according to the operation status can be realized by the above-described combination of the color liquid crystal display panel and the touch panel. However, it is necessary some improvements for portable electronic devices such as a digital camera and a mobile phone because various constraints such as outdoor use and reduction in thickness are given to them.

For example, a switch portion of an apparatus disclosed in Patent Document 2 is a stacked body composed of a liquid crystal display panel and translucent LEDs and a touch panel. In a plan view, a plurality of translucent LEDs having different emission colors exist in switch regions displayed on the liquid crystal panel. Upon a press on the switch region, the touch panel detects the press position and informs an operator of various kinds of information by the translucent LEDs flashing or changing in emission color. This apparatus has a feature of good visibility even under sunlight because the status of the switch can be indicated by bright emission of the translucent LEDs.

Each of the examples shown thus far has a configuration in which a transparent touch panel is stacked on the liquid crystal display panel. In this structure, attenuation of light when passing through the touch panel and reflection on the surface of the touch panel are unavoidable. Countermeasures against to them, a switch sheet is provided under the liquid crystal display element composed of a flexible substrate such as plastic in some apparatuses. In this case the switch sheet can be opaque.

For example, Patent Document 3 discloses an apparatus in which a switch array, a lighting sheet using electroluminescence, and a flexible liquid crystal display panel are stacked.

In this apparatus, when a switch region shown on a flexible liquid crystal display panel is pressed by a finger, the flexible liquid crystal display panel and the lighting sheet at that portion are deformed to press the switch of the switch array at the lowermost layer, thereby conducting the switch. Note that this apparatus is characterized in that display contents of the switch region are programmable so that the display contents are changed depending on the operation status and function of the apparatus.

The apparatus disclosed in Patent Document 3, however, can perform display only in one color because the electroluminescence is used as the lighting sheet. Therefore, the apparatus cannot satisfy the demand to change also the color according to the function and status of the switch.

Patent Document 1: JP 2000-259347A

Patent Document 2: JP 2006-244292A

Patent Document 3: JP 63-132323A

### SUMMARY OF THE INVENTION

The invention has been developed in consideration of various problems encountered in the above-described conventional touch inputting devices, and its object is to provide a liquid crystal display device which can clearly display a key region and so on by a liquid crystal display panel without attenuation and reflection of light, and can indicate the status of a switch which is stacked on the liquid crystal display panel, by variously changing its display color when the switch is pressed.

To achieve the above object, the invention is a liquid crystal display device including a liquid crystal display panel having a liquid crystal layer between two flexible substrates, a lighting device capable of illuminating the liquid crystal display panel with lights of a plurality of colors, and a switch sheet which senses a press thereon, configured as follows.

The lighting device includes a flexible light guide sheet arranged on a rear surface side or a front surface side of the liquid crystal display panel, and the switch sheet, the light guide sheet, and the liquid crystal display panel are stacked such that the switch sheet is capable of being locally pressed from the front surface side of the liquid crystal display panel.

A field sequential color (FSC) drive circuit is further provided which causes the lighting device to repeat an illumination period in which only a light of a predetermined color of the lights of the plurality of colors is used, for each of the colors in order, and causes the liquid crystal display panel to perform a display corresponding to the color in synchronization with the illumination period for each of the colors.

The light guide sheet is preferably disposed between the switch sheet and the liquid crystal display panel. Alternatively, the substrate of the liquid crystal display panel can also be used as the light guide sheet.

Further, a capacitive sensor sheet may be provided stacked on the liquid crystal display panel.

It is more preferable that the lighting device includes an LED element which emits lights of three colors of red, green and blue as a light source, and the light emitted from the LED element is incident on a side surface of the light guide sheet.

Alternatively, it is more preferable that the lighting device includes a linear light source which emits lights of three colors of red, green and blue, and the light emitted from the linear light source is incident on a side surface of the light guide sheet.

It is desirable that a reflection layer is provided between the light guide sheet and the switch sheet.

Moreover, it is preferable that a low power consumption drive circuit is provided which stops the illumination by the lighting device and causes the liquid crystal display panel to display in a reflection display mode by ambient light.

Further, it is preferable that a drive frequency is lower when the liquid crystal display panel is driven by the low power consumption drive circuit than when the panel is driven by the field sequential color (FSC) drive circuit.

The liquid crystal display device according to the invention can be easily reduced in size and weight and freely bent as a whole, can clearly display the key regions and so on without attenuation and reflection of light, and can indicate the statuses of the keys by variously changing their display

The above and other objects, features and advantages of the invention will be apparent from the following detailed description which is to be read in conjunction with the accompanying drawings.

### BRIEF DESCRIPTION OF THE DRAWINGS

FIG. 1 is an exploded perspective view showing a configuration of the first embodiment of a liquid crystal display device according to the invention;

FIG. 2 is an enlarged schematic sectional view showing a portion of the liquid crystal display device;

FIG. 3 is an enlarged schematic sectional view showing a portion near its liquid crystal layer;

FIG. 4 is a plan view showing examples of switch regions of the liquid crystal display device;

FIG. 5 is a block diagram showing an example of a drive circuit of the liquid crystal display device;

FIG. 6 is a timing chart showing an example of driving waveforms by the drive circuit;

FIG. 7 is an exploded perspective view showing a configuration of the second embodiment of the liquid crystal display device according to the invention;

FIG. 8 is an exploded perspective view similar to that in FIG. 7, showing a configuration of the third embodiment of the liquid crystal display device according to the invention;

FIG. 9 is an enlarged schematic sectional view showing a portion of its liquid crystal display panel; and

FIG. 10 is a perspective view showing a mobile phone incorporating the liquid crystal display device according to the invention with its main display portion open.

### DETAILED DESCRIPTION OF THE PREFERRED EMBODIMENTS

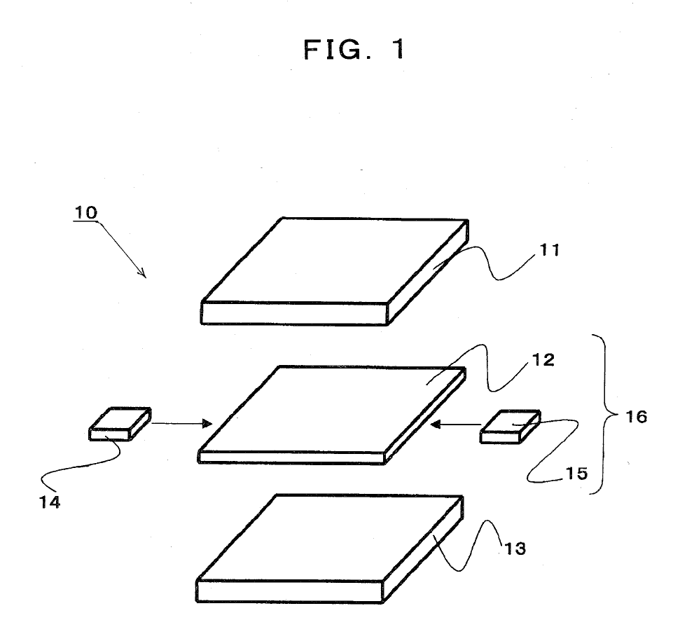

Referring to FIG. 1 to FIG. 10, a preferred embodiment of the invention will be described below.

### First Embodiment

### FIG. 1 to FIG. 6

FIG. 1 is an exploded perspective view showing a configuration of the first embodiment of a liquid crystal display device according to the invention.

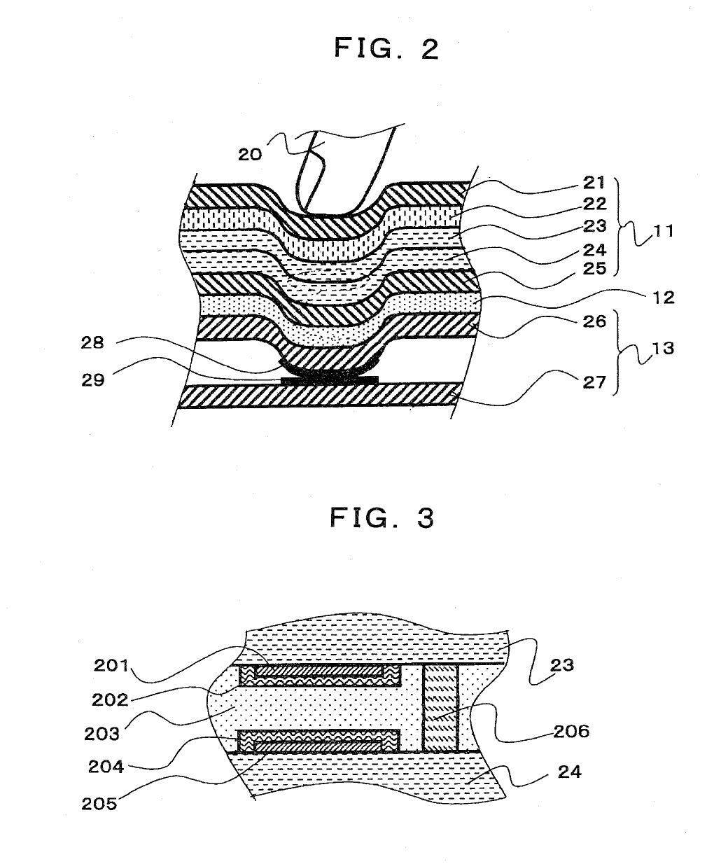

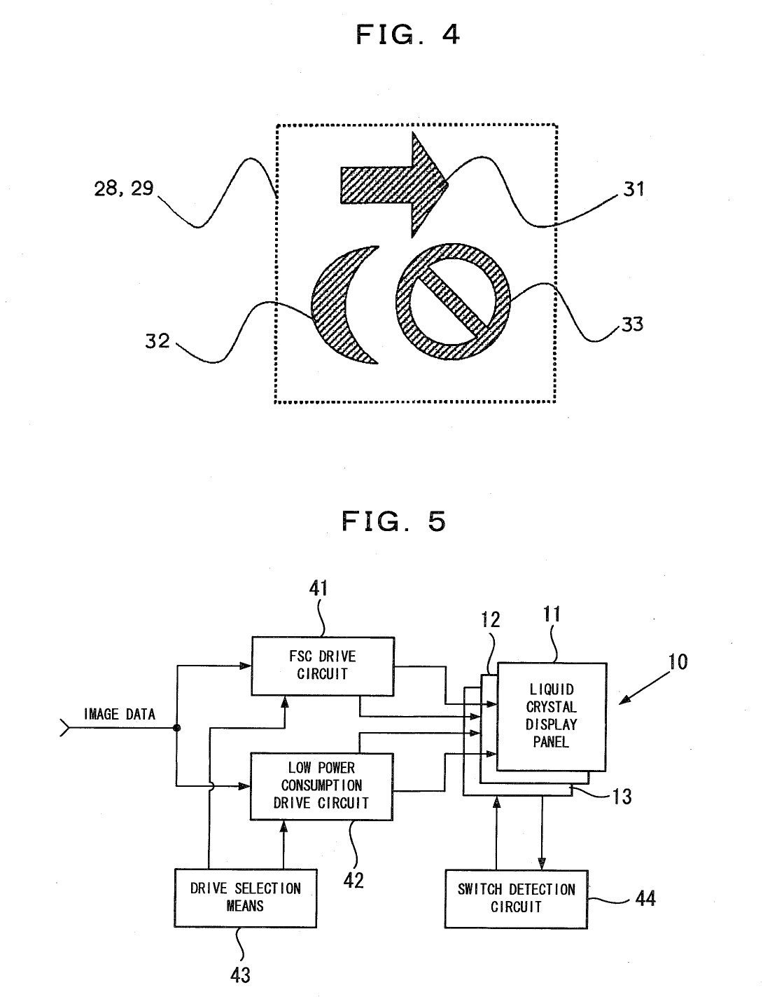

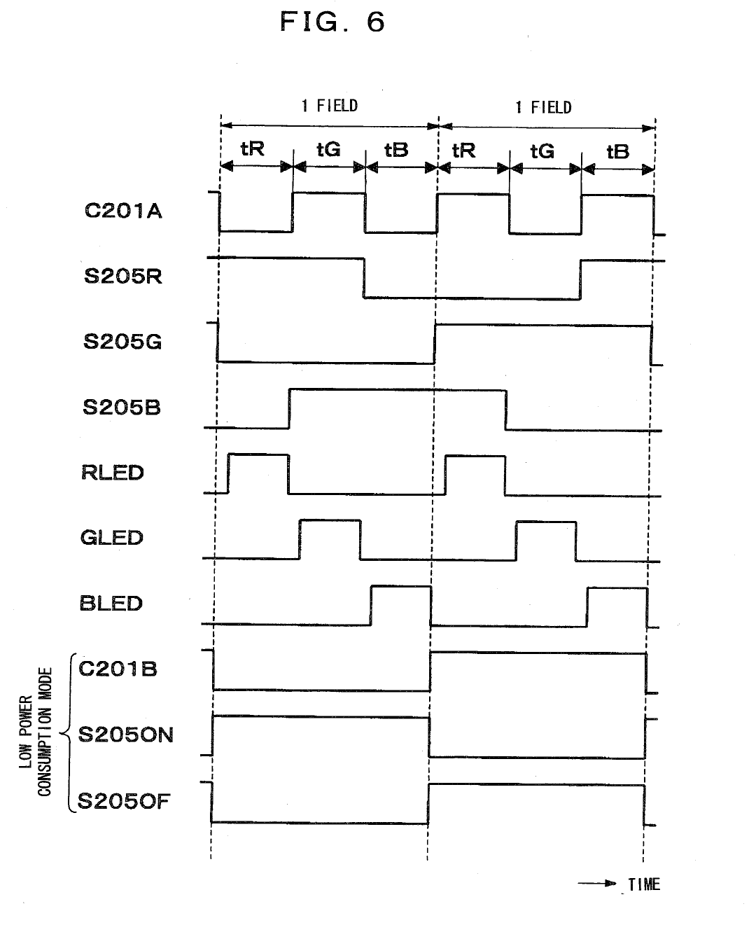

FIG. 2 is an enlarged schematic sectional view showing a portion of the liquid crystal display device, and FIG. 3 is an enlarged schematic sectional view showing a portion near a liquid crystal layer. FIG. 4 is a plan view showing examples of switch regions of the liquid crystal display device. FIG. 5 is a block diagram showing an example of a drive circuit of the liquid crystal display device according to the invention, and FIG. 6 is a chart showing an example of its driving waveforms. Note that in the description of these drawings, the same numbers and symbols are given to the same or corresponding portions to omit repeated description for them.

A liquid crystal display device 10 shown in FIG. 1 has a switch sheet 13 and a flexible liquid crystal display panel 11 stacked with a light guide sheet 12 of a lighting device 16 intervening therebetween so that the switch sheet 13 can be locally pressed from the outer surface of the flexible liquid crystal display panel 11. On the switch sheet 13, many switches (not shown) sensing the press are arranged.

The lighting device 16 is a lighting device which can illuminate the liquid crystal display panel 11 with lights of a plurality of colors, and has the light guide sheet 12 having flexibility (plasticity) and LED elements 14 and 15 as light sources arranged facing each other on two side surfaces of the light guide sheet 12 substantially orthogonal to a light emerging direction (a stack direction). The lights emitted from the LED elements 14 and 15 are incident on the light guide sheet 12 through the side surfaces of the light guide sheet 12 (in directions shown by arrows). Each of the LED elements 14 and 15 is also called a three-color LED and can individually control light emission of red, green and blue by control signals.

The stack structure of members constituting the liquid crystal display device 10 will be described in more detail with FIG. 2 and FIG. 3.

The liquid crystal display panel 11 is a flexible liquid crystal display panel which has a liquid crystal layer sandwiched between a lower substrate 24 and an upper substrate 23 which are two flexible substrates, and further has a polarizing plate 25 stacked on the lower side of the lower substrate 24 and a retardation film 22 and a polarizing plate 21 stacked on the upper side of the upper substrate 23. The thickness of each of the polarizing plates 21 and 25 and the retardation film 22 is about 100 μm.

A portion near the liquid crystal display panel 11 is shown in more detail in FIG. 3. A liquid crystal is filled in a space formed by the lower substrate 24, the upper substrate 23 and a seal (not shown) to form a liquid crystal layer 203. On opposed inner surfaces of the upper and lower substrate 23 and 24, transparent electrodes 201 and 205 are formed respectively, and alignment films 202 and 204 are formed on them respectively. To keep the thickness of the liquid crystal layer 203 constant, a spacer 206 fixed to the substrate 23 or 24 is formed by the photolithography process.

The upper and lower substrates 23 and 24 are made of a transparent flexible resin such as a polycarbonate or the like with a thickness of about 100 μm. The transparent electrodes 201 and 205 are made of indium tin oxide (ITO) and formed in a thickness of about 0.03 μm to ensure flexibility. Each of the alignment films 202 and 204 is made of polyimide and has a thickness of about 0.05 μm. Many transparent electrodes 201 and 205 are formed in the shape of dot-matrix, orthogonal stripes, or segments, and one of the transparent electrodes 201 and 205 can be a common entire electrode (a common electrode).

The liquid crystal layer 203 is a nematic liquid crystal with a twist angle of 240° which is generally called a super twisted nematic (STN) liquid crystal and known as having a high switching speed during static drive. Its layer thickness is about 4 μm.

Returning to FIG. 2, the light guide sheet 12 of the lighting device 16 is composed of silicone rubber having a thickness of about 100 μm and is coated with a reflection layer on the surface on the switch sheet 13 side.

The switch sheet 13 is composed of a relatively rigid base substrate 27, a soft top substrate 26, and a plurality of electrodes 28 and 29 adhering to the opposed surfaces of the top and base substrates 26 and 27 respectively.

When a portion of the flexible liquid crystal display panel 11 of the liquid crystal display device 10 corresponding to the electrodes 28 and 29 is pressed from the outer surface of the flexible liquid crystal display panel 11 by a finger or the like as shown in FIG. 2, the liquid crystal display panel 11, the light guide sheet 12, and the top substrate 26 of the switch sheet 13 corresponding to the portion locally bend to lower, thereby bringing the upper and lower electrodes 28 and 29 into contact to turn ON. During no press, the upper and lower electrodes 28 and 29 are kept separated (OFF).

The relationship within a plane between a region (hereinafter, referred to as a “pixel”) where the transparent electrodes 201 and 205 of the liquid crystal display panel 11 overlap each other and the switching electrodes 28 and 29 of the switch sheet 13 will be described with FIG. 4.

In this example, three pixels 31, 32 and 33 exist within the region of the switching electrodes 28 and 29. One of the three pixels 31, 32 and 33 is electively turned on (displayed) depending on the operation mode of the liquid crystal display panel 11. Assuming that the transparent electrode 201 forms the common electrode and the transparent electrode 205 forms the segment electrode, one transparent electrode 201 and three transparent electrodes 205 exist in the region where the switching electrodes 28 and 29 exist.

FIG. 5 shows an example of the drive circuit of the liquid crystal display device. The drive circuit is composed of an FSC drive circuit 41, a lower power consumption drive circuit 42, and a drive selection means 43 which selects one of the drive circuits 41 and 42 and causes the selected drive circuit to operate. A numeral 44 denotes a switch detection circuit which detects the ON/OFF state of each of the switches arranged on the switch sheet 13 by a scan operation or the like. The drive selection means 43 can be made to perform selection operation by operating an external switch or using one of the switches by the electrodes on the switch sheet 13 of the liquid crystal display device 10.

The FSC drive circuit 41 is a circuit which causes the LED elements 14 and 15 to separately emit lights of red, green, and blue colors in order at a predetermined cycle so that the lighting device 16 illuminates the liquid crystal display panel 11, while applying a drive voltage to the liquid crystal of each of the pixels of the liquid crystal display panel 11 according to image data corresponding to a display color in synchronization with the illumination period of each of the colors, thereby performing color display. This drive is called a Field Sequential Color (FSC) drive.

The low power consumption drive circuit 42 is a circuit which stops of the light emission of the lighting device 16 or causes the lighting device 16 to emit lights of only one color, while applying a drive voltage to the liquid crystal of each of the pixels of the liquid crystal display panel 11 according to image data at a cycle longer than the predetermined cycle of the FSC drive, thereby performing black-and-white display or mono-color display. This drive is called a low power consumption drive.

Next, the FSC drive (an FSC mode) by the FSC drive circuit 41 and the low power consumption drive (a low power consumption mode) by the low power consumption drive circuit 42 will be described using FIG. 6.

In the FSC drive, one field is composed of red, green and blue subfield periods tR, tG and tB. FIG. 6 shows two field periods and shows a case in which the transparent electrode 201 forms the common electrode and the transparent electrode 205 forms the segment electrode as described above. To the transparent electrode 201, a drive signal C201A is applied during the FSC drive, and a drive signal C201B is applied during the low power consumption mode. Note that the amplitudes of the drive signals applied to the transparent electrodes 201 and 205 are 10 V, and the field frequencies are 70 Hz.

First, the case of the FSC drive will be described. The drive signal C201A is inverted every subfield period. To bring the pixel into a transmission state only during the red subfield period tR and into a non-transmission state during the green and blue subfield periods tG and tB, a drive signal S205R is applied to the transparent electrode 205. The drive signal S205R has a reversed polarity to that of the drive signal C201A only during the red subfield period tR to apply a predetermined voltage between the transparent electrode 201 and the transparent electrode 205.

To similarly bring the pixel into the transmission state only during the green subfield period tG, a drive signal S205G is applied to the transparent electrode 205. The drive signal S205G has a reversed polarity to that of the drive signal C201A only during the green subfield period tG to apply a predetermined voltage between the transparent electrode 201 and the transparent electrode 205.

To bring the pixel into the transmission state only during the blue subfield period tB, a drive signal S205B is applied to the transparent electrode 205. The drive signal S205B has a reversed polarity to that of the drive signal C201A only during the blue subfield period tB to apply a predetermined voltage between the transparent electrode 201 and the transparent electrode 205.

The LED elements 14 and 15 of the lighting device 16 emit red light when a control signal RLED is at a high level. Similarly, LED elements 14 and 15 of the lighting device 16 emit green and blue lights when control signals GLED and BLED are at a high level, respectively.

Application of the drive signal S205R to the transparent electrode 205 establishes the transmission state only during the subfield period tR, while the LED elements 14 and 15 are emitting red light, so that the pixel appears red. Note that to prevent mixture of colors to increase the purity, the timing to start light emission is delayed from the start of the subfield period tR by a response time of the liquid crystal. This also applies to the case where the pixel is displayed in another color. It is generally known that the FSC drive can perform full-color display by devising the drive waveform on the segment electrode side, for example, modulating the pulse width.

Next, the case of the low power consumption drive will be described. In the low power consumption drive, a drive signal C201B is applied to the transparent electrode 201 as shown at a lower portion in FIG. 6. To bring the pixel into the transmission state, a drive signal S205ON having a reversed polarity to that of the drive signal C201B is applied to the transparent electrode 205. To bring the pixel into the non-transmission state, a drive signal S205OF having the same polarity of that of the drive signal C201B is applied.

In the low power consumption drive, the LED elements 14 and 15 of the lighting device 16 are not tuned on if ambient light is available. Further, by reducing the drive frequency of the liquid crystal display panel 11, a further reduction in power consumption is achieved. The drive signal amplitude can also be reduced to ⅓ of that during the FSC drive, thereby further reducing the power consumption. Since the rear surface of the light guide sheet 12 is coated with the reflection layer, the light guide sheet 12 serves as a reflection plate during the low power consumption drive so that the pixel performs mirror-reflection in the transmission state whereas it turns black in the non-transmission state. In other words, the liquid crystal display panel 11 is turned into a reflection display mode by ambient light. Such a configuration enables a reduction in power consumption in a state in which key input is possible.

However, for use in a dark environment with insufficient ambient light or the like, it is also possible to cause the LED elements 14 and 15 of the lighting device 16 to emit lights of only one color, while applying a drive voltage with a cycle longer than the predetermined cycle and a smaller amplitude than that of the FSC drive to the liquid crystal of each of the pixels of the liquid crystal display panel 11, thereby performing mono-color display.

Note that a reflection layer may be formed on the upper surface of the switch sheet 13, or a reflection sheet may be provided to intervene between the switch sheet 13 and the light guide sheet 12 to form a reflection layer.

Alternatively, the low power consumption drive circuit 42 and the drive selection means 43 in FIG. 5 may be omitted so that only the FSC drive is performed.

### Second Embodiment

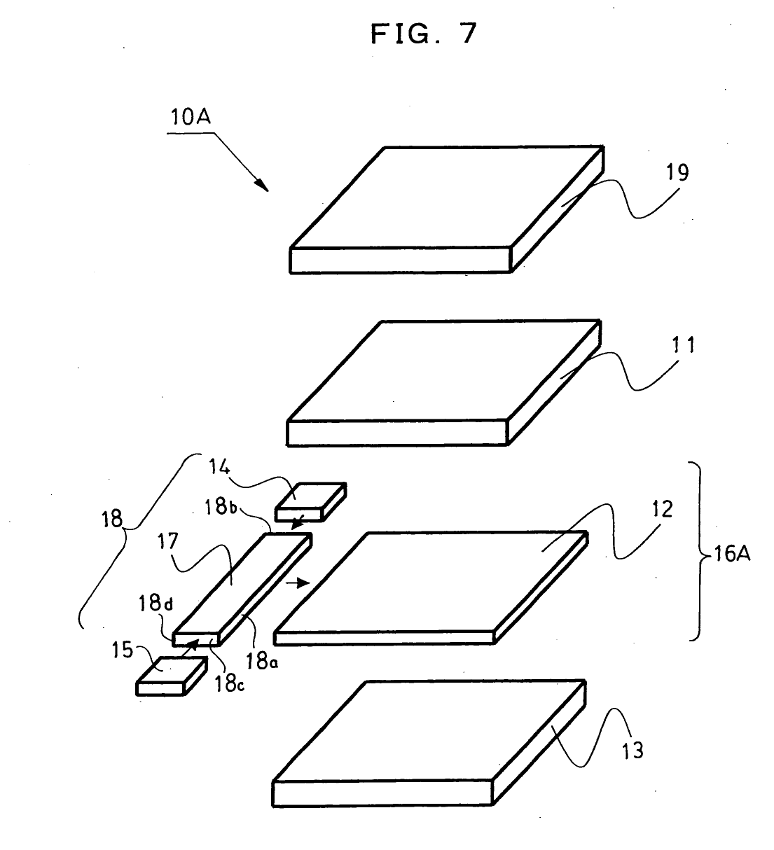

### FIG. 7

Next, the second embodiment of the liquid crystal display device according to the invention will be described. FIG. 7 is an exploded perspective view similar to that in FIG. 1, showing the configuration of the device.

A liquid crystal display device 10A has a capacitive sensor sheet 19 stacked on the liquid crystal display panel 11 of the liquid crystal display device 10 shown in FIG. 1. Further, in place of the lighting device 16, a lighting device 16A composed of a light guide sheet 12 and a linear light source 18 is disposed.

The capacitive sensor sheet 19 is formed such that many electrodes made of ITO are arranged on the lower surface of a transparent insulating PET sheet made of polyethylene terephthalate (PET), and can detect the contact position by the capacitance change between electrodes when a finger touches the front surface of the PET sheet.

The linear light source 18 is formed such that a prism piece 17 which has almost the same thickness as that of the light guide sheet 12 and almost the same length of that of one side surface of the light guide sheet 12 is disposed with its exit surface 18a that is one of long side surfaces facing the one side surface of the light guide sheet 12 in parallel, and LED elements 14 and 15 that are a pair of three-color LEDs are arranged facing short side surfaces 18b and 18c of the prism piece 17.

One of red, green and blue lights emitted by each of the LED elements 14 and 15 is incident on the prism piece 17 through each of the short side surfaces 18b and 18c, made uniform while being reflected off a reflection-type prism formed on a long side surface 18d opposite the exit surface 18a, uniformly exits from the entire surface of the exit surface 18a, and is incident on the light guide sheet 12 through the one side surface and scattered and reflected therein, to almost uniformly illuminate the entire surface of the liquid crystal display panel 11 from the upper surface of the light guide sheet 12.

The drive circuit of the liquid crystal display device 10A of the second embodiment is similar to the drive circuit shown in FIG. 5 and its FSC drive and low power consumption drive are also similar to those of the drive circuit. Note that a touch detection circuit is provided which detects a touch position from the capacitance change of each of the electrodes on the capacitive sensor sheet 19. For example, the touch detection circuit scans the electrodes on the capacitive sensor sheet to measure the capacitance values of the electrodes. From the measured values, the coordinates of the touch position could be obtained. For small capacitances of these electrodes, there are known methods of measuring time (the number of pulses) to reach a reference voltage and of measuring the oscillation frequency of an oscillator using the capacitance of the electrode.

Provision of the capacitive sensor sheet 19 ensures that the liquid crystal display device 10A of this embodiment can fetch information when the surface is stroked or lightly touched, by the capacitive sensor sheet 19 and control the display state of the liquid crystal display panel 11 and the function or the like of an apparatus equipped with the liquid crystal display device 10A.

On the other hand, when strongly pressed, the liquid crystal display device 10A can fetch the information into the switch sheet 13, as in the above-described liquid crystal display device 10 of the first embodiment and control the display state of the liquid crystal display panel 11 and the function and the like of the apparatus equipped with the liquid crystal display device 10A. In this case, the information from the capacitive sensor sheet 19 is usually disabled.

Further, use of the linear light source 18 as the light source of the lighting device 16A enables a reduction in size and equalization of illumination light. More specifically, since the LED elements 14 and 15 being point light sources face on and are directly attached to the side surfaces of the light guide sheet 12 in the first embodiment shown in FIG. 1, it is necessary to provided regions to scatter the lights emitted from the LED elements planarly along the attached sides so as to uniformly illuminate the display region, between the LED elements 14 and 15 and the display region in the light guide sheet 12. In contrast, in the second embodiment shown in FIG. 7, the light emerging toward the light guide sheet 12 has been previously uniformed, thus eliminating the need to provide the regions to scatter the lights, leading to a reduction in size of the display device.

Various Modifications

Note that the capacitive sensor sheet 19 may be stacked on the liquid crystal display panel 11 while the employed lighting device is the lighting device 16 as it is as in the first embodiment, or only the lighting device may be changed with the lighting device 16A composed of the light guide sheet 12 and the linear light source 18 shown in FIG. 7 while the capacitive sensor sheet 19 is not provided.

Further, in any of the embodiments, the light guide sheet 12 of the lighting device is arranged on the rear surface (the lower surface) side of the liquid crystal display panel 11 to form a backlight, in which a uniform plane illumination for the liquid crystal display panel 11 is more easily realized, but the light guide sheet 12 of the lighting device may be arranged on the front surface (the upper surface) side of the liquid crystal display panel 11 to form a front light.

In this case, it is necessary to scatter and reflect downward the light incident from the side surface by light emission of the light source. For example, on the upper surface side of the light guide sheet 12, a reflection-type-prism sheet is provided. In this event, a reflection layer or a reflection sheet is provided on the rear surface (the lower surface) side of the liquid crystal display panel 11.

Further, in the case of backlight, the lower substrate 24 shown in FIG. 2 and FIG. 3 of the liquid crystal display panel 11 can also be used as the light guide sheet 12 of the lighting device. On the other hand, in the case of front light, the upper substrate 23 of the liquid crystal display panel 11 can also be used as the light guide sheet 12 of the lighting device.

### Third Embodiment

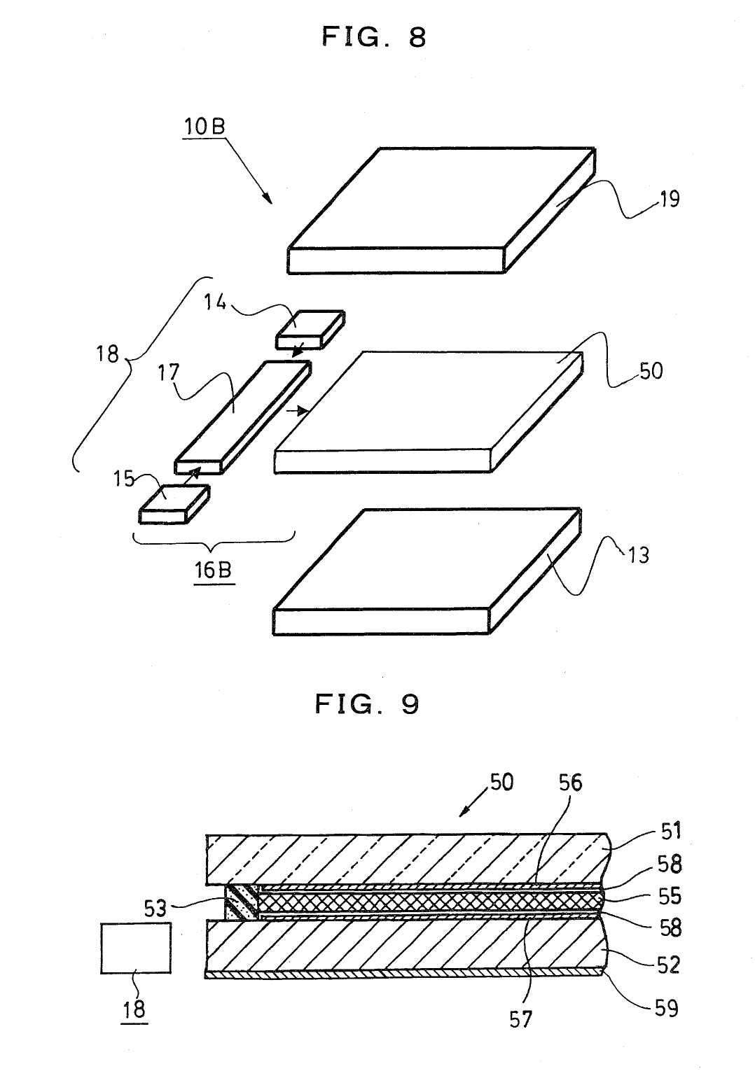

### FIG. 8 and FIG. 9

Next, the third embodiment of the liquid crystal display device according to the invention will be described. FIG. 8 is an exploded perspective view similar to that in FIG. 7, showing its configuration, and FIG. 9 is an enlarged schematic sectional view showing a portion of its liquid crystal display panel.

A liquid crystal display device 10B shown in FIG. 8 uses a polymer-dispersed liquid crystal display panel 50 in place of the liquid crystal display panel 11 in the liquid crystal display device 10A shown in FIG. 7. In this example, a lower substrate of the liquid crystal display panel 50 is also used as a light guide sheet of a lighting device 16B, and therefore is not provided with the light guide sheet 12 in FIG. 7. The remaining configuration is similar to that of the second embodiment described with FIG. 7, in which a linear light source 18 is used for the light source, and a capacitive sensor sheet 19 is stacked on the liquid crystal display panel 50.

The liquid crystal display panel 50 is configured such that two flexible substrates 51 and 52 are bonded together at their peripheral portions using a sealing material 53 as shown in FIG. 9 and a polymer-dispersed liquid crystal layer 55 is sandwiched between them. The flexible substrates 51 and 52 are flexible transparent plastic films such as polycarbonate, PET, PES or the like (having a thickness of about 100 μm). On opposed inner surfaces of the two substrate 51 and 52, transparent electrodes 56 and 57 made of ITO or the like having a film thickness of about 30 nm are formed respectively. The electrodes 56 and 57 are formed as stripe electrodes orthogonal to each other, or the entire surface electrode and segments electrodes, or pixel electrodes composed of dot matrix electrodes, but both the electrodes 56 and 57 are simplified in FIG. 9 and shown as integral electrode films.

The polymer-dispersed liquid crystals are often classified depending on the way of mixing the polymer regions and the liquid crystal regions. The polymer-dispersed liquid crystal display layer 55 used in this embodiment is a solid polymer-dispersed liquid crystal thin film (a film thickness of about 5 to about 15 μm) in which a liquid crystal is dispersed in a polymeric material in a sponge form or network form. When no voltage is applied between the electrodes 56 and 57 holding the polymer-dispersed liquid crystal layer 55 therebetween the polymer-dispersed liquid crystal layer 55 scatters light and becomes opaque because the refractive indices the polymeric material and the liquid crystal are different, whereas when an appropriate magnitude of voltage is applied, the polymer-dispersed liquid crystal layer 55 becomes transparent because the refractive indices of the polymeric material and the liquid crystal are almost the same.

The polymer-dispersed liquid crystal layer 55 is fabricated by injecting a mixed liquid of an ultraviolet curable resin liquid (for example, an acrylic resin liquid) and a photopolymerization initiator and a liquid crystal (a nematic liquid crystal or the like) through a not-shown injection port of the sealing material 53 into a predetermined gap between the substrates 51 and 52 bonded together with the gap kept therebetween with the sealing material 53, sealing the injection port, and then applying ultraviolet ray from the outside. By the application of the ultraviolet ray, only the resin undergoes a polymerization reaction to form a polymer network, and the liquid crystal undergoes phase separation and disperses in the polymer network. In this state, the polymer network by the ultraviolet curable resin is fixed to the inner surfaces (including the surfaces of the electrodes 56 and 57) of the substrates 51 and 52.

Hence, undulation in a waveform is applied to the whole liquid crystal display panel 50 to separate the polymer-dispersed liquid crystal layer 55 from the flexible resin substrates 51 and 52 to thereby form substantially uniform fine gaps 58 between them. Such a configuration ensures that even if a touch (press) is locally applied on the same portion of the display surface of the liquid crystal display panel 50 many times, any impression hardly occurs, and that even if an impression occurs, the display surface of the liquid crystal display panel 50 recovers so that the impression disappears in a short Even though the polymer-dispersed liquid crystal layer 55 is separated from the substrates 51 and 52 as described above, the polymer-dispersed liquid crystal layer 55 is never displaced in the plane direction when a press is applied thereon since the periphery of the polymer-dispersed liquid crystal layer 55 is positionally restricted by the sealing material 53.

On the lower surface of the lower substrate 52 of the polymer-dispersed liquid crystal display panel 50, a reflection layer 59 is formed. In place of the reflection layer 59, a reflection layer may be formed on the upper surface of the switch sheet 13, or a reflection sheet may be disposed between the liquid crystal display panel 50 and the switch sheet 13.

Further, the linear light source 18 is disposed facing one side surface 52a of the lower substrate 52 of the liquid crystal display panel 50. One of lights of a plurality of colors from the linear light source 18 is incident on the substrate 52, and advances while being reflected upward by the reflection layer 59, whereby the polymer-dispersed liquid crystal layer 55 is illuminated. In short, the lower substrate 52 is also used as the light guide sheet of the lighting device 16B.

The polymer-dispersed liquid crystal layer 55 is not limited to the above-described type in which the liquid crystal is dispersed in the ultraviolet curable polymer network but may be of other kinds. For example, the polymer-dispersed liquid crystal layer can also be formed by applying a polymer-dispersed liquid crystal material onto one of the substrates and drying and solidifying it and then stacking the other substrate on the one substrate and laminating them.

According to this embodiment, even if a touch is locally applied on the same portion of the display surface of the liquid crystal display panel 50 many times, any impression hardly occurs, and even if an impression occurs, the display surface of the liquid crystal display panel 50 recovers so that the impression disappears in a short time, so that an easily-viewable screen can be maintained for a long time. Further, since the light guide sheet of the lighting device can be omitted, this embodiment is effective in reducing the cost and size. Other effects are the same as those of the second embodiment.

The drive circuit of the liquid crystal display device 10B of the third embodiment is also the same as the drive circuit shown in FIG. 5, in which it is only required to provide a touch detection circuit which detects a touch position from the capacitance change of each of the electrodes on the capacitive sensor sheet 19.

Note that the capacitive sensor sheet 19 may be omitted, or the LED elements 14 and 15 which emit lights of red, green, and blue as in the first embodiment may be used as the light source in place of the linear light source 18.

Further, the upper substrate 51 on the upper side of the liquid crystal display panel 50 can also be used as the light guide sheet of the lighting device 16B to form a front light which illuminates the polymer-dispersed liquid crystal layer 55 from its front surface side. Light may be made incident on the upper and lower substrates 51 and 52 at the same time.

The numerical values in the above-described embodiments such as the thickness of the substrates and the film thickness of the electrodes show their examples, and it goes without saying that those numerical values may be changed as necessary depending on the usage, the whole size and other conditions.

Installation Example in Mobile Phone

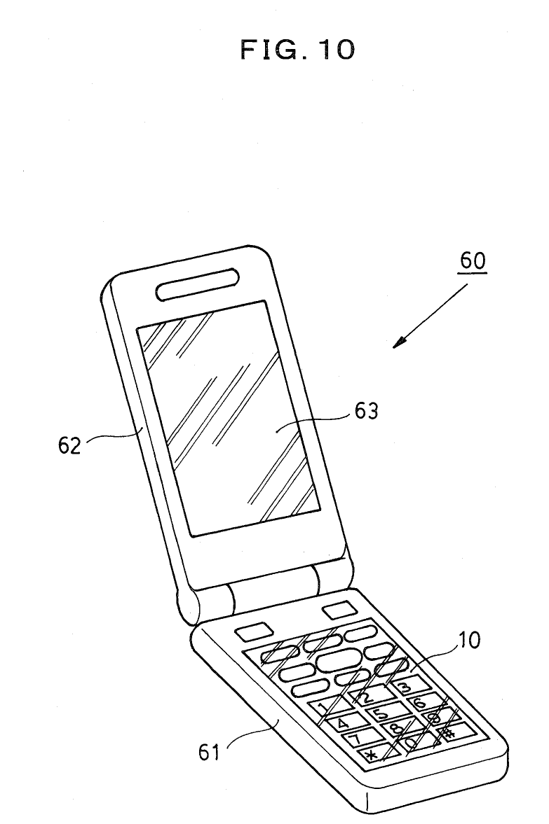

Next, an installation example of the liquid crystal display device according to the invention in a mobile phone will be described. FIG. 10 is a perspective view showing a mobile phone incorporating the liquid crystal display device according to the invention with its main display portion open.

A mobile phone 60 has a main body portion 61 and a main display portion 62 coupled to each other to be able to open and close, the main display portion 62 being provided with a main display 63 constituted of a color liquid crystal display panel. On the upper surface of the main body portion, the liquid crystal display device 10 according to the invention (the device 10 here as a representative, though any of the liquid crystal display devices in the above-described embodiments may be employed) is mounted as a keypad.

In the liquid crystal display panel of the liquid crystal display device 10, keys such as the ten keys and various function selection keys and the like as same as the keys of the keypad of a typical mobile phone are displayed in the initial state, so that dial input and function selection can be performed by a touch to each of the key display regions. Further, the key display can also be changed according to the function selection, and display colors of only the subsequently operable keys can be changed.

Further, only keys through which input is possible are displayed in specific colors, the display colors of the keys on the main panel can be associated with the display colors of the keys of the keypad, and the colors of the keys can be freely set by a user, resulting in increased fashionability and operability.

The liquid crystal display device according to the invention can be easily reduced in size and weight and freely bent as a whole, can clearly display the key regions and so on without attenuation and reflection of light, and can indicate the statuses of the keys by variously changing their display colors.

Therefore, the liquid crystal display device is most suitable as the keypads of various portable electronic devices such as a mobile phone and a personal digital assistant, and can be applied also to operation panels of other various devices to realize the operation panel in a curved shape.

What is claimed is:

1. A liquid crystal display device comprising a liquid crystal display panel having a liquid crystal layer between two flexible substrates, a lighting device capable of illuminating the liquid crystal display panel with lights of a plurality of colors, and a switch sheet which senses a press thereon,
said lighting device including a flexible light guide sheet arranged on a rear surface side or a front surface side of said liquid crystal display panel,
said switch sheet, said light guide sheet, and said liquid crystal display panel being stacked, and said switch sheet being capable of being locally pressed from the front surface side of said liquid crystal display panel,
wherein said liquid crystal display device further comprises:
a field sequential color drive circuit,
said field sequential color drive circuit causing said lighting device to repeat an illumination period in which only a light of a predetermined color of the lights of the plurality of colors is used, for each of the colors in order, and causing said liquid crystal display panel to perform a display corresponding to the color in synchronization with the illumination period for each of the colors.

2. The liquid crystal display device according to claim 1,
wherein said light guide sheet is disposed between said switch sheet and said liquid crystal display panel.

3. The liquid crystal display device according to claim 1,
wherein the substrate of said liquid crystal display panel is also used as said light guide sheet.

4. The liquid crystal display device according to claim 1, further comprising:
a capacitive sensor sheet stacked on said liquid crystal display panel.

5. The liquid crystal display device according to claim 2, further comprising:
a capacitive sensor sheet stacked on said liquid crystal display panel.

6. The liquid crystal display device according to claim 1,
wherein said lighting device includes an LED element which emits lights of three colors of red, green and blue as a light source, and the light emitted from said LED element is incident on a side surface of said light guide sheet.

7. The liquid crystal display device according to claim 4,
wherein said lighting device includes an LED element which emits lights of three colors of red, green and blue as a light source, and the light emitted from said LED element is incident on a side surface of said light guide sheet.

8. The liquid crystal display device according to claim 1,
wherein said lighting device includes a linear light source which emits lights of three colors of red, green and blue, and the light emitted from said linear light source is incident on a side surface of said light guide sheet.

9. The liquid crystal display device according to claim 4,
wherein said lighting device includes a linear light source which emits lights of three colors of red, green and blue, and the light emitted from said linear light source is incident on a side surface of said light guide sheet.

10. The liquid crystal display device according to claim 1, further comprising:
a reflection layer provided between said light guide sheet and said switch sheet.

11. The liquid crystal display device according to claim 2, further comprising:
a reflection layer provided between said light guide sheet and said switch sheet.

12. The liquid crystal display device according to claim 4, further comprising:
a reflection layer provided between said light guide sheet and said switch sheet.

13. The liquid crystal display device according to claim 1, further comprising:
a low power consumption drive circuit which stops the illumination by said lighting device and causes said liquid crystal display panel to display in a reflection display mode by ambient light.

14. The liquid crystal display device according to claim 10, further comprising:
a low power consumption drive circuit which stops the illumination by said lighting device and causes said liquid crystal display panel to display in a reflection display mode by ambient light.

15. The liquid crystal display device according to claim 11, further comprising:
a low power consumption drive circuit which stops the illumination by said lighting device and causes said liquid crystal display panel to display in a reflection display mode by ambient light.

16. The liquid crystal display device according to claim 12, further comprising:
a low power consumption drive circuit which stops the illumination by said lighting device and causes said liquid crystal display panel to display in a reflection display mode by ambient light.

17. The liquid crystal display device according to claim 13,
wherein a drive frequency is lower when said liquid crystal display panel is driven by said low power consumption drive circuit than when said panel is driven by said field sequential color drive circuit.

18. The liquid crystal display device according to claim 14,
wherein a drive frequency is lower when said liquid crystal display panel is driven by said low power consumption drive circuit than when said panel is driven by said field sequential color drive circuit.

19. The liquid crystal display device according to claim 15,
wherein a drive frequency is lower when said liquid crystal display panel is driven by said low power consumption drive circuit than when said panel is driven by said field sequential color drive circuit.

20. The liquid crystal display device according to claim 16,
wherein a drive frequency is lower when said liquid crystal display panel is driven by said low power consumption drive circuit than when said panel is driven by said field sequential color drive circuit.
